(19) United States
(12) Patent Application Publication
(10) Pub. No.: US 2017/0185751 A1
(43) Pub. Date: Jun. 29, 2017

(54) METHODS AND DEVICES FOR ANONYMOUS PROCESSING OF MEDICAL STUDIES

(71) Applicant: Neerav Mehta, Swarthmore, PA (US)

(72) Inventor: Neerav Mehta, Swarthmore, PA (US)

(21) Appl. No.: 15/391,774

(22) Filed: Dec. 27, 2016

Related U.S. Application Data
(60) Provisional application No. 62/271,977, filed on Dec. 28, 2015.

(51) Int. Cl. G06F 19/00; G06Q 50/24

(52) U.S. Cl. CPC G06F 19/366; G06F 19/322; G06F 19/3443; G06F 19/363; G06Q 50/24; G06F 19/32; G06F 19/321; G06F 19/36; G06Q 50/22

(57) ABSTRACT

The various embodiments provide methods and systems for anonymously processing medical studies within a diagnostic healthcare environment. The embodiment methods and systems may provide efficient means for providing expert professionals with medical, legal, or other studies for review, without revealing client-identifying information. The embodiment methods and systems may further provide a means for obtaining professional expert opinion about case evidence from a number of experts all at the same time. The experts may be anonymous with reference to the requesting user (e.g., an attorney) and thus may be shielded from subpoena or further inquiry. The experts may also be free of biases as they would be unaware of the context and associations of the professional case review. Thus, the systems and methods of the various embodiments may provide a double-blind analysis of case evidence such as medical studies.

### CROSS REFERENCE TO RELATED APPLICATIONS

This application claims the benefit f priority under 35 U.S.C. 119 to provisional application No. 62/271977 entitled “Methods and Devices for Anonymous Processing of Medical Studies” filed on Dec. 28, 2016, the entirety of which is incorporated herein by reference.

### FIELD OF THE INVENTION

The present invention relates to methods and systems for automating and managing workflow for image analysis, more particularly managing workflow of medical image analysis studies within a diagnostic healthcare environment.

### BACKGROUND OF THE INVENTION

Typical problems involved in the provision of expert opinions in malpractice suits include the limiting of personally identifying patient information to only those persons who are directly involved in the case, and the obtaining of review from qualified professionals without bias. Many experts may be reluctant to provide an analysis of evidence if they feel that doing so will require them to testify or subject them to possible subpoena. Similarly, plaintiffs may be reluctant to solicit opinions from multiple experts because doing so may require the repeated disclosure of personal information. Knowledge of the context of medical record review by a qualified expert may also bias their opinion. A system and method for providing blind case evidence analysis, in which neither a requesting user, nor evaluating experts are aware of the other's identity may address the problems discussed above. Such systems may further enable the crowdsourcing of case evidence results to provide more reliable expert opinion free of bias.

### SUMMARY

The various embodiments provide methods and systems for anonymously processing medical studies within a diagnostic healthcare environment. The embodiment methods and systems may provide efficient means for providing expert professionals with medical, legal, or other studies for review, without revealing client-identifying information. The embodiment methods and systems may further provide a means for obtaining professional expert opinion about case evidence from a number of experts all at the same time. The experts may be anonymous with reference to the requesting user (e.g., an attorney) and thus may be shielded from subpoena or further inquiry. Thus, the systems and methods of the various embodiments may provide a double-blind analysis of case evidence such as medical studies.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a communication system block diagram illustrating network components of an example medical study-processing network and component devices that are suitable for use with the various embodiments.

FIG. 2 is a process flow diagram illustrating a method of anonymously processing a medical study in accordance with various embodiments.

FIG. 3 is a component diagram of an example computing device in the form of a smart phone suitable for use with the various embodiments.

FIG. 4 is a component block diagram of a server device suitable for use with the various embodiments.

### DETAILED DESCRIPTION

The various embodiments will be described in detail with reference to the accompanying drawings. Wherever possible, the same reference numbers will be used throughout the drawings to refer to the same or like parts.

Privacy of workflow in a crowd sourced medical study review system is very important to the patients and clinicians alike. With doctors and diagnostic equipment in high demand and ever increasing pressures on healthcare institutions to protect privacy, it is very important to maintain anonymized data flows across the study review system. This is particularly important for the review of medical history reports by physicians, in preparation for malpractice litigation. Specialists willing to provide an opinion on the practice of colleagues are always in short supply and constant demand. In order to provide an opinion on malpractice case evidence, these specialists require detailed images, accurate patient data, and medical records. The more specialists that review a case, the greater the impact of their collective findings. For example, the expert opinion as to a standard of care, provided by a single specialist may be controvertible. But, the impact of the same opinion evidence, provided by 20 independent specialists with no personal knowledge of the patient or each other, may carry significantly more weight. Thus, the more specialists that review a medical study, the more faith a finder of fact can place on the resulting expert evidence.

In order to shield specialists from the rebukes of colleagues who disapprove of providing malpractice opinions, and to reduce the likelihood that a specialist will need to appear in court to defend his or her opinions, the systems and methods of the various embodiments provide an anonymous crowdsourcing of medical study analysis. Various embodiments may include removing the personally identifying information of a patient from a medical study to prevent reviewing clinicians from forming any opinion or bias about the patient. The reviewing clinicians may be selected from a secure data store acting as a “black box”, inaccessible to requesting users. The system may select reviewing clinicians based on the nature of the medical study (e.g., radiological, obstetric, cardiovascular, etc.) and may indicate one or more approved physicians associated with the medical provider. Thus, a reviewing medical provider may appoint one of the approved physicians to review the anonymized medical study and provide an opinion. In some embodiments, the approved clinicians may be vetted and approved by a third party vendor, or a system administrator to ensure that all providers listed in the data store are qualified as experts in their field of practice and are competent to review and provide opinion on the medical study. The results of review by each clinician may be aggregated to generate a patient report that indicates a consensus about the contents of opinion on the medical study.

In this description, a “medical study” normally refers to a message or data structure containing information about a patient and a requested diagnostic procedure for the patient. A study order (or simply order) is a request for a primary set of medical reports, diagnostic images, audio, and/or video, of the patient and for subsequent analysis to be performed by an imaging specialist or diagnostic physician. A resulting patient report is sometimes referred to as a “patient report” because it is a compiled composite of all medical study files and study results received from each medical provider within the study processing network.

The provider identifiers within an intermediate document (i.e., anonymized medical study) may be alphanumeric or encoded identifiers that correspond to the routing of the images and other information needed to perform a particular medical study analysis. The provider identifiers may identify a particular medical service provider, but may not be associated with a any specific clinician associated with the medical service provider. The destination of the images and information may be a participating group of physicians (e.g., medical provider) or an individual physician. The destination is controlled by a set of customized workflow routing rules programmed by an administrator. The workflow routing rules may be conditionally based upon any combination of the modality of the image (or images), medical history, a body part of interest in the medical study, location of the patient, and so on.

The various embodiments can be configured as combinations of hardware and software providing seamless connectivity between all acquisition and analysis systems. An embodiment is built upon an underlying infrastructure of components, which work together to enable an interoperable enterprise healthcare system. The underlying infrastructure may be composed of existing computer networks, servers, information systems, imaging systems, workstations, personal computers, and other network nodes in communication with each other. The infrastructure may also include application software executing on the network infrastructure. The software may be distributed among the nodes, such as servers and workstations, and may include client and server software components.

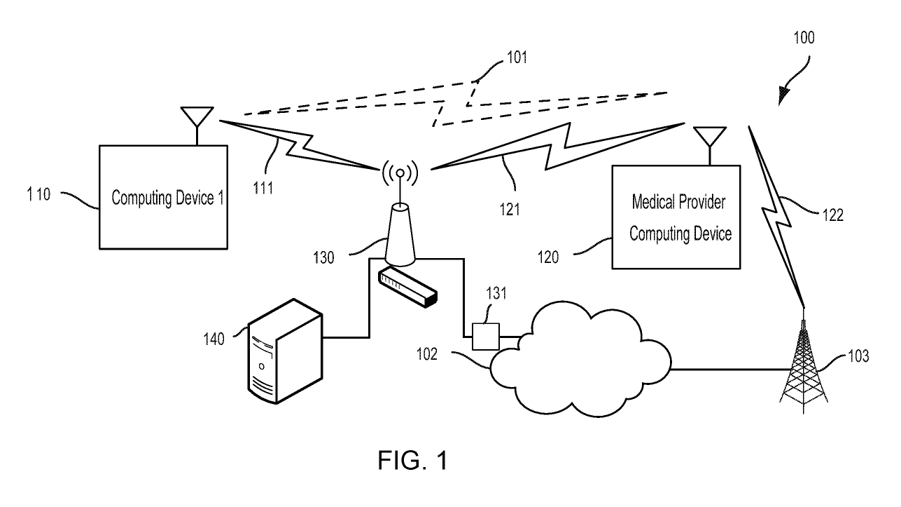

FIG. 1 illustrates a simple example of an interoperable system infrastructure within a distributed medical diagnostic system. A networked or distributed system of computing devices, such as illustrated in FIG. 1, may be linked by any of various hardware and communications protocols, such as Ethernet, TCP/IP, Internet, wireless IEEE 802.11, cellular, or other established or emerging data communication technologies.

The various embodiments may be implemented within a variety of communication systems, such as the example communication system 100 illustrated in FIG. 1. In an embodiment, a communication system 100 may include multiple medical provider computing devices 120, such as a smart communication device (e.g., smartphone, tablet, laptop etc.). The medical provider computing device 120 may communicate with a first computing device 110 (e.g., smart devices) through links 111, 121 established with an access point 130 (e.g., wireless access point, wireless router, etc.). The links 111, 121 may be wireless, or may be wired such as in an Ethernet connection or a power line communication (PLC) connection, or other wired connection. In an alternative embodiment or embodiments, the medical provider computing devices 120 may connect directly with the smart device 110 through a direct link 101. Further in an alternative embodiment or embodiments, the first computing device 110 may connect with each medical provider computing device 120, either through a direct link (e.g., link 110) or through a link provided through the access point 130. The access point 130 may be connected to the Internet 102 through a service provider 131. In embodiments, a local network server 140 may be present in the network and may be incorporated into a networking framework.

In various further alternative embodiments, the medical provider computing devices 120 may connect to the network through a cellular infrastructure 103, which may refer collectively to cellular infrastructure components for providing cellular service. The cellular infrastructure 103 may include a component or series of components, which may include some or all of as a cellular antenna, base station (e.g., eNodeB), and so on. The medical provider computing devices 120 may connect to the access point 130 through a connection provided by the cellular infrastructure 103 through a public network such as the Internet 102, or a private network based on a Universal Resource Locator (URL) associated with the access point 130. For security reasons, access to the network through the access point 130 may be password protected, may use encryption, may use other security measures or may use a combination of security provisions.

The communication system 100 may further include network servers 140 connected to the telephone network and to the Internet 102. The connection between the network servers 140 and the telephone network may be through the Internet 102 or through a private network. A network server 140 may also be implemented as a server within the network infrastructure of a cloud service provider network. Communication between the network server 140 and the computing devices device 110, 120 may be achieved through wireless data networks, the telephone network, the Internet 102, a private network (not illustrated), or any combination thereof.

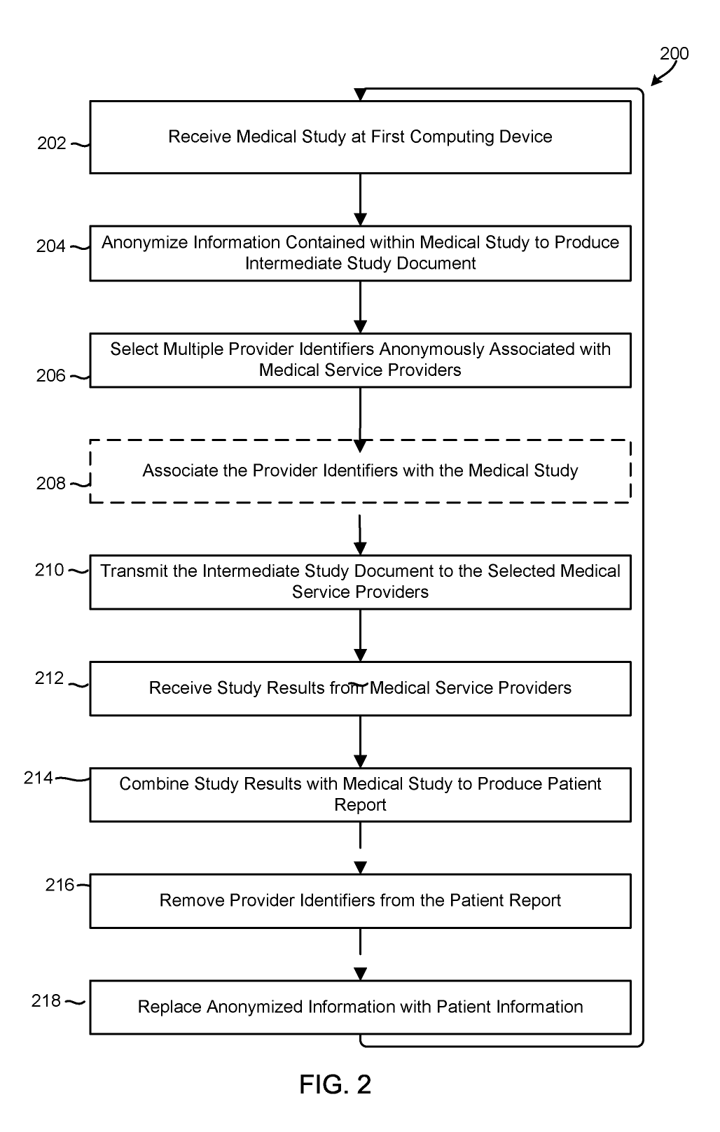

FIG. 2 illustrates an embodiment method of providing anonymous processing of medical studies (e.g., computing devices 110, 120) in accordance with the various embodiments. Embodiment methods may be carried out by computing devices having processors configured to execute operations of the methods. Various embodiments may enable a first computing device to receive a patient study order, remove identifying information from the study order, and submit the anonymized study order to multiple approved medical providers for review. Approved clinicians may review the anonymized study order and generate study results. The study results may be received by the first computing device and combined into a patient report that contains the various study results without identifying the names of examining clinicians.

In block 202, a transceiver of the first computing device may receive a medical study. The medical study may be a collection of documents pertaining to a patient record, an accident report, treatment history, or the like. The medical study may be transmitted to the first computing device by a requesting party, third party vendor, or even the patient themselves. In some embodiments, the medical study may contain image files, such as radiological images. In some embodiments, the medical study may contain prognosis and diagnosis information from clinicians who have previously reviewed the patent's medical information. The medical study may contain text-based documents, image files, audio files, video files, and the like. Thus, the anonymization and distribution of the medical study by the embodiment systems and methods may present a technical solution that would otherwise elude analog attempts to redact patient information from a physical medical history containing diverse file formats.

In block 204, a processor of the computing device, may anonymize the medical study to produce an intermediate document. Anonymizing the medical study may include stripping personally identifying information from all documents, images, and audio-video files. Personally identifying information may include social security numbers, patient identifiers, names, addresses, and the like. The scope of personally-information may be defined under the Health Insurance Portability and Accountability Act (HIPAA) and thus need not be fully addressed herein. In some embodiments, the personally identifying information may be replaced with alternate characters (e.g., a random string of characters). In some embodiments, the processor may remove the personally-identifying information. In some embodiments, the processor may replace the personally identifying information with markers that may enable the processor to later replace the information.

In block 206, the first computing device or a remote server may select multiple provider identifiers associated with medical providers. Various embodiments may include, accessing a data storage containing information relating to multiple medical service providers. Various embodiments may include data stores located on the first computing device. In some embodiments, the data store may be a database stored remotely. In various embodiments, the medical provider information may be inaccessible to a user of the first computing device. For example, the medical provider identifiers may be selected by the processor of the first computing device or by a remote server, and associated provider identifiers may be obtained without inspection by a requesting user. In some embodiments, the multiple provider identifiers may be selected at random. In some embodiment, the multiple provider identifiers may be selected according to a predefined selection algorithm.

Various embodiments may include medical provider information that includes provider identifiers, provider names, provider medical specializations, approved clinician names, and data routing information (e.g., network address, MAC address, email address, etc.). The selecting processor may filter the data storage based on a required medical specialization (e.g., radiology, orthopedics, etc.) and may then apply the selection algorithm, or random selection process. Provider identifiers of the selected medical providers may be obtained by the first computing device, either by retrieval from storage or transmission from the remote server. The data routing information of the selected medical providers may be used to send the intermediate document (i.e., anonymized medical study) to computing device of the medical providers (e.g., computing devices 120). Optionally, in block 208, the processor of the first computing device may associate the provider identifiers of the selected medical providers with the medical study. Associating the provider identifiers with the medical study may enable efficient pairing of study results received from the selected medical providers to the medical study at a later time.

In block 210, the processor of the first computing device or the remote server, may transmit the intermediate document to each of the selected medical service providers based on the provider identifiers. Various embodiments may include the first computing device (i.e., computing device 110) using the obtained medical provider information to transmit the intermediate document to the different medical providers. In some embodiments, the intermediate document may be transmitted to the remote server as part of a request for selection of medical providers. Such embodiments may include the remote server transmitting the intermediate document to the selected medical providers. Such embodiments may further remove the requesting user of the first computing device from the operation of communicating directly with the multiple medical providers.

A medical provider receiving the intermediate document may assign any approved clinician to review the contents of the received intermediate document. For example, a medical practice may have several clinicians approved to provide radiological analyses. A subset of those clinicians may be further approved to provide neurological radiology analyses. The assignment of an intermediate study to a clinician within the internal network of the medical service provider may be at the discretion of the medical service provider. Various embodiments may include study results that do not contain any personally-identifying information relating to the reviewing clinician. In some embodiments, the medical service provider may internally retain information linking a reviewing clinician to a case number of the intermediate document.

In block 212, the first computing device may receive study results from multiple medical providers. The study results may be the result of a clinician analysis of the intermediate document (i.e., the anonymized medical study). Clinicians approved for review, may accept the intermediate document, review its contents and provide input regarding an expert opinion. The study results may be a file or set of files generated at a medical provider computing device and transmitted to the first computing device. In block 214, the first computing device may receive the multiple study results from different medical provider computing devices. Various embodiments may include associating, by the first computing device, the study results, with the intermediate document to create a patient report. The patient report may thus be a combined collection of the multimedia files of the medical study and the resulting study results. In various embodiments, the patient report may contain only anonymized information at the time of generation. Provider identifiers associated with each study result may be used to link the study to the original medical study or the intermediate document.

In block 216, the processor of the first computing device may remove the provider identifiers from the patient report. The first computing device may analyze the combined files to isolate any instances of provider identifiers and may remove the same. In this manner, the first computing device may strip the patient report of any information linking the study results to specific medical providers. In some embodiments, the provider identifiers may be retained until the patient report has been reviewed by a supervising clinician. Study results containing errors may be resubmitted via the first computing device, which may then return the offending study result to the medical provider associated with the provider identifier. Once the patient report is approved, all provider identifiers may be removed. In block 218, the first computing device may optionally replace the anonymized patient information with some or all of the original personally-identifying patient information. Thus the patient report may be the sum of blind medical review by a number of approved medical professionals without bias toward the patient or the case. The resulting medical study may contain no indication of the reviewing professionals, thereby shielding reviewing clinicians from involvement in court proceedings.

In some embodiments, the operations of block 216 may be carried out by a computing device of the medical service provider. The medical service provider may redact, remove, scramble, or otherwise obfuscate the provider identifier from the study results. Thus, the study result may be received by the first computing device in block 218 with no visible indication of the originator of the study result.

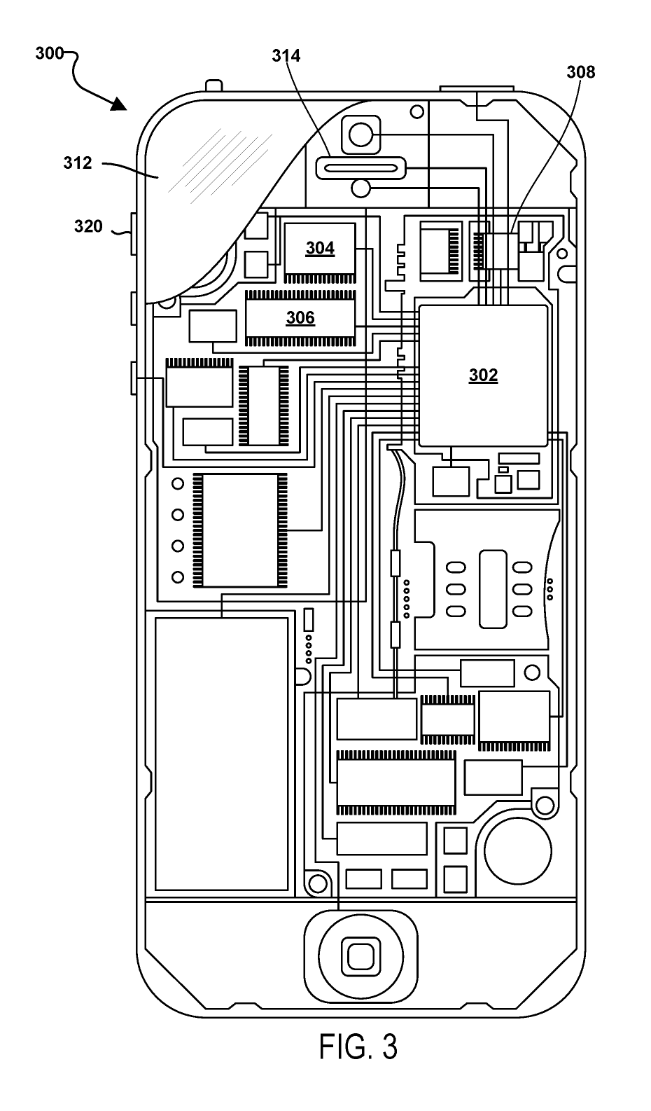

The various embodiments may be implemented on a variety of computing devices, an example of which is illustrated in FIG. 3 in the form of a smartphone. A smartphone 900 may include a processor 302 coupled to internal memory 304, a display 312, and to a speaker 314. Additionally, the smartphone 300 may include an antenna for sending and receiving electromagnetic radiation that may be connected to a wireless data link and/or cellular telephone transceiver 308 coupled to the processor 302. Smartphones 300 typically also include menu selection buttons or rocker switches 320 for receiving user inputs.

A typical smartphone 300 also includes a sound encoding/decoding (CODEC) circuit 306, which digitizes sound received from a microphone into data packets suitable for wireless transmission and decodes received sound data packets to generate analog signals that are provided to the speaker to generate sound. Also, one or more of the processor 302, wireless transceiver 308 and CODEC 306 may include a digital signal processor (DSP) circuit (not shown separately).

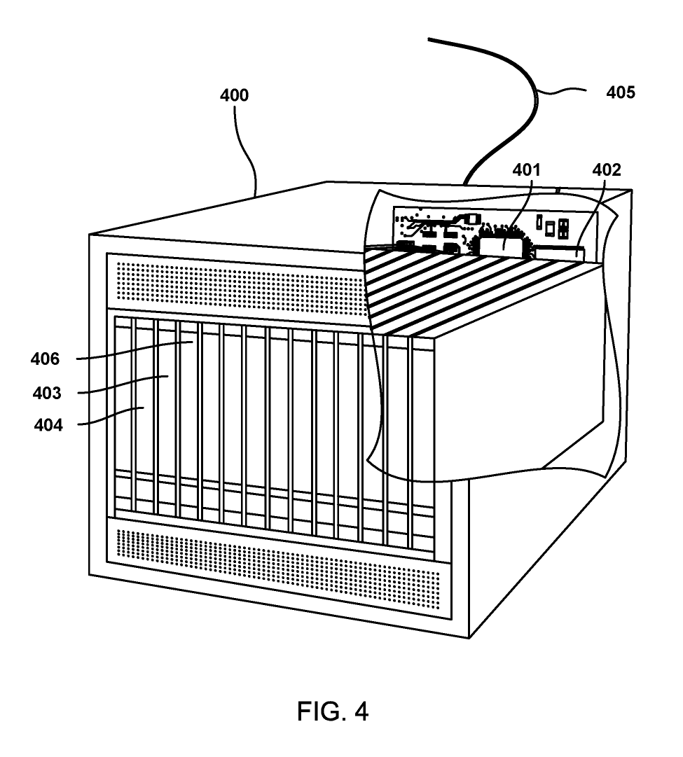

Portions of the embodiment methods may be accomplished in a client-server architecture with some of the processing occurring in a server, such as maintaining databases of normal operational behaviors, which may be accessed by a computing device processor while executing the embodiment methods. Such embodiments may be implemented on any of a variety of commercially available server devices, such as the server 400 illustrated in FIG. 4. Such a server 400 typically includes a processor 401 coupled to volatile memory 402 and a large capacity nonvolatile memory, such as a disk drive 403. The server 1100 may also include a floppy disc drive, compact disc (CD) or DVD disc drive 404 coupled to the processor 401. The server 400 may also include network access ports 406 coupled to the processor 401 for establishing data connections with a network 405, such as a local area network coupled to other broadcast system computers and servers.

The processors 302, 401 may be any programmable microprocessor, microcomputer or multiple processor chip or chips that can be configured by software instructions (applications) to perform a variety of functions, including the functions of the various embodiments described below. In some computing devices, multiple processors 302, 401 may be provided, such as one processor dedicated to wireless communication functions and one processor dedicated to running other applications. Typically, software applications may be stored in the internal memory 304, 402, 403 before they are accessed and loaded into the processor 302, 401. The processor 302, 401 may include internal memory sufficient to store the application software instructions.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as device code) whose format is understandable by a processor.

The foregoing method descriptions and the process flow diagrams are provided merely as illustrative examples, and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” “engine,” “generator,” “manager,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, a device, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

I claim:

1. A method for anonymous processing of medical studies, comprising:
receiving a medical study at a first computing device;
anonymizing, by a processor of the first computing device, information contained within the medical study to produce an intermediate study document;
selecting, by the processor, multiple provider identifiers anonymously associated with medical service providers from a storage;
transmitting the intermediate study document to computing devices of the medical service providers anonymously identified by the selected multiple provider identifiers;
receiving study results from the medical service providers;
combining the study results with the medical study based on the multiple provider identifiers to produce a patient report;
removing the multiple provider identifiers from the patient report; and
replacing the anonymized information with original information that personally identifies a patient.

2. The method of claim 1, wherein anonymizing the information contained within the medical study comprises:
removing personally identifying patient information from the medical study.

3. The method of claim 1, wherein anonymizing the information contained within the medical study comprises:
replacing personally identifying patient information with unrelated information.

4. The method of claim 1, wherein the medical study is an imaging study.

5. The method of claim 1, wherein selecting, by the processor, the multiple provider identifiers anonymously associated with medical service providers from a storage, comprising:
accessing a database that is inaccessible to users; and
obtaining from the database, information for addresses of computing devices belonging to medical service providers and anonymized identifiers associated with the medical service providers.

6. The method of claim 5, wherein the medical service providers are chosen by the processor, at random.

7. The method of claim 1, wherein the intermediate report and received study results are inaccessible to a user of the first computing device.

8. The method of claim 1, wherein the medical study is inaccessible to a user of the computing devices of the medical service providers.

9. The method of claim 1, further comprising associating the medical study with the multiple provider identifiers;

10. A computing device, comprising:
a network interface;
a processor coupled to the network interface and configured to:
receive a medical study;
anonymize information contained within the medical study to produce an intermediate study document;
select multiple provider identifiers anonymously associated with medical service providers from a storage;
transmit the intermediate study document to computing devices of the medical service providers anonymously identified by the selected multiple provider identifiers;
receive study results from the medical service providers;
combine the study results with the medical study based on the multiple provider identifiers to produce a patient report;
remove the multiple provider identifiers from the patient report; and
replace the anonymized information with original information that personally identifies a patient.

11. A computing device, comprising:
means for receiving a medical study;
means for anonymizing information contained within the medical study to produce an intermediate study document;
means for selecting multiple provider identifiers anonymously associated with medical service providers from a storage;
means for transmitting the intermediate study document to computing devices of the medical service providers anonymously identified by the selected multiple provider identifiers;
means for receiving study results from the medical service providers;
means for combining the study results with the medical study based on the multiple provider identifiers to produce a patient report;
means for removing the multiple provider identifiers from the patient report; and replacing the anonymized information with original information that personally identifies a patient.

12. A non-transitory processor readable medium having stored thereon processor executable instructions for causing a processor of a medical device to perform operations comprising:
receiving a medical study;
anonymizing information contained within the medical study to produce an intermediate study document;
selecting multiple provider identifiers anonymously associated with medical service providers from a storage;
transmitting the intermediate study document to computing devices of the medical service providers anonymously identified by the selected multiple provider identifiers;
receiving study results from the medical service providers;
combining the study results with the medical study based on the multiple provider identifiers to produce a patient report;
removing the multiple provider identifiers from the patient report; and
replacing the anonymized information with original information that personally identifies a patient.
